(19) United States
(12) Patent Application Publication
(10) Pub. No.: US 2013/0286896 A1
(43) Pub. Date: Oct. 31, 2013

(54) TELECOMMUNICATIONS AND COMPUTER NETWORK INTERCONNECTIVITY APPARATUSES AND METHODS THEREOF

(71) Applicant: Selph Secured LLC, (US)

(72) Inventors: Joseph Haley Selph, Myrtle Beach, SC (US); John T. Bullock, Firestone, CO (US)

(21) Appl. No.: 13/835,306

(22) Filed: Mar. 15, 2013

Related U.S. Application Data
(60) Provisional application No. 61/639,643, filed on Apr. 27, 2012.
(60) Provisional application No. 61/658,678, filed on Jun. 12, 2012.

(51) Int. Cl. H04L 12/70; H01R 31/06

(52) U.S. Cl. CPC H04L 49/55; H01R 31/06
USPC 370/255; 439/651

(57) ABSTRACT

A single line network interconnectivity apparatus includes a system board, one or more female Ethernet ports, an Ethernet data receiving port (EDRP), an Ethernet data transfer port (EDTP), and a data switch. The data switch includes at least one of configurable hardware logic configured to implement or a processor coupled to a memory and configured to execute programmed instructions stored in the memory including obtaining at least one network data packet from the EDRP. The data packet is communicated to the female Ethernet port, when it is determined that the identifier included in the network packet matches the identifier associated with the computing device connected to the female Ethernet port. The data packet is communicated to the EDTP, when it is determined that the identifier included in the data packet does not match the identifier associated with the computing device connected to the female Ethernet port.

This application claims the benefit of U.S. Provisional Patent Application Ser. No. 61/639,643, filed Apr. 27, 2012, and U.S. Provisional Patent Application Ser. No. 61/658,678, filed Jun. 12, 2012, each of which is hereby incorporated by reference in its entirety.

### FIELD OF THE INVENTION

This technology generally relates to interconnectivity apparatuses and installation methods for telecommunications and computer networks and, more particularly, to apparatuses and methods for reducing the amount of network cable and other resources required to install large networks.

### BACKGROUND OF THE INVENTION

Workstation areas in many local area network (LAN) environments have significant network connectivity requirements for telecommunication and computing devices. These requirements include connectivity at network wall outlets distributed throughout the environment. In order to comply with accepted industry installation standards, each network outlet module must have a single Main Distribution Frame (MDF) or Intermediate Distribution Frame (IDF) originating cable run attached to it. Within a digital LAN only one computing device can be connected with each Ethernet outlet module, unless a switch or hub is used to branch out addition connections. Within an analog LAN, many devices can be connected together with a single run of cable. Exemplary standards are defined in TIA/EIA-568 established by the Telecommunications Industry Association/Electronic Industries Alliance.

Digital and or Ethernet network connections require a significant amount of network cable, many other supplies, time, and effort for installation, particularly when the network outlets contain multiple Ethernet ports. In some networks, even a home run connection with a network outlet will not comply with industry installation standards due to the significant distance of the outlet from a distribution frame. Moreover, network connectivity requirements generally change over time as an organization grows or realigns its physical or logical layout or as network components or devices are updated. Maintaining industry installation standards as networks evolve provides additional challenges not faced during a new network installation due in part to the existing physical structures of the environment and inflexibility of existing network outlets.

With respect to analog telecommunications networks, installers often use connectors, such as Scotchlock™ connectors available from 3M Co. of St. Paul, Minn., in order to make a daisy chain type of connection. However, with this type of connection method, network cable wires can loosen from the connectors over time and network data can be distorted or intermittently dropped. Accordingly, telecommunications networks having connectors connecting network components can exhibit reduced quality of data transmission, which is not desirable.

The present invention is directed to overcoming these and other deficiencies in the art.

### SUMMARY OF THE INVENTION

An analog network interconnectivity apparatus includes a housing including a first side and a second side. The first side of the housing includes a female connection port and the second side includes a network cable punch down electronic continuity receiving bay (ECRB) and a network cable punch down electronic continuity continuation bay (ECCB). The ECRB and the ECCB each include continuity connection points. The apparatus further includes a single to dual electronic circuit board attached to the housing. The single to dual electronic circuit board includes a plurality of electrically conductive paths extending between the female port and the ECRB and ECCB. The electrically conductive paths are configured to communicate electric signals received by the ECRB to at least one of the female port or the plurality of continuity connection points of the ECCB.

An analog network outlet adapter apparatus includes a housing including a first side and a second side. The first side of the housing includes a female port and the second side includes a male plug. A circuit board is attached to the housing and includes electrically conductive paths extending between the female port and the male plug. The electrically conductive paths are configured to communicate electric signals between the female port and the male plug.

The apparatus further includes a network outlet faceplate configured to receive the housing through an aperture and attach to the housing toward the first end. Additionally, at least one locking/releasing lever extends through the network outlet faceplate and is configured to operatively move both the network outlet faceplate and attached housing away from the wall a short distance so that the network adapter can be moved along a type of guide track in order to slide it to the next desired installed network interconnectivity apparatus within a workstation area.

A single line network interconnectivity apparatus includes a system board having mounted thereto one or more female Ethernet ports, an Ethernet data receiving port (EDRP), an Ethernet data transfer port (EDTP), and a data switch. The data switch includes at least one of configurable hardware logic configured to implement or a processor coupled to a memory and configured to execute programmed instructions stored in the memory including obtaining at least one network data packet from the EDRP. In some examples, the EDRP is an automatically generated crossover Ethernet port that is capable of sending data back up a single line from which it received the data. Whether an identifier included in the data packet matches an identifier associated with a computing device connected to the female Ethernet port is determined. The data packet is communicated to the female Ethernet port, when it is determined that the identifier included in the network packet matches the identifier associated with the computing device connected to the female Ethernet port.

The data packet is communicated to the EDTP, when it is determined that the identifier included in the data packet does not match the identifier associated with the computing device connected to the female Ethernet port. This allows the data packet to be transferred to the correct computing device along the connected single run of Ethernet cable. Optionally, in some examples, the single line network interconnectivity apparatus further includes an electronic data repeater configured to repeat data packets as needed within network connections involving long segments or ranges.

In some examples, the system board is housed within a durable protective shroud. The shroud and the apparatus it contains can be attached within an electrical gang box or any other securing source desired within any area of a workstation. Also, in some examples, the system board includes electrically conductive paths extending between the female Ethernet ports, EDRF, EDTP, data switch, and electronic data repeater. The electrically conductive paths are configured to communicate electric signals including data packets.

This technology provides a number of advantages including interconnectivity apparatuses and installation methods that reduce the amount of network cable and other supplies required to provide network outlets in workstation areas. With this technology, telecommunication and computer networks can be installed that include a single continuous run to each network outlet without a home run of network cable from a distribution frame to each of the outlets or each Ethernet port at each outlet. Accordingly, resources required to install, or to change the physical or logical layout of, a telecommunication or computer network can be significantly reduced.

### BRIEF DESCRIPTION OF THE DRAWINGS

FIG. 1 is a perspective view of an exemplary network interconnectivity apparatus according to one embodiment of the present invention for use in a telecommunications network;

FIG. 2 is a rear, perspective view of the exemplary network interconnectivity apparatus of FIG. 1;

FIG. 3 is an exemplary interior, perspective view of the exemplary network interconnectivity apparatus of FIG. 1;

FIG. 4 is a side, perspective view and a face view of an exemplary network outlet adapter apparatus according to one embodiment of the present invention;

FIG. 5 is an interior, perspective view of the exemplary network outlet adapter apparatus of FIG. 4;

FIG. 6 is a flowchart of an exemplary method of installing a plurality of the network interconnectivity apparatuses of FIG. 1 in a telecommunications network;

FIG. 7 is a schematic diagram of a prior art telecommunications network with a home run connection between a distribution frame and a plurality of network outlets;

FIG. 8 is a schematic diagram of an exemplary telecommunications network according to one embodiment of the present invention with a single continuous connection of a plurality of network outlets to a distribution frame using a plurality of the exemplary network interconnectivity apparatuses of FIG. 1;

FIG. 9 is a flowchart of an exemplary method of installing a plurality of the network interconnectivity apparatuses of FIG. 1B in a computer network;

FIG. 10 is an exemplary workstation area according to one embodiment of the present invention with a plurality of network outlets attached to a plurality of exemplary guide track devices;

FIG. 11 is an exemplary network outlet faceplate according to one embodiment of the present invention for use with a guide track device;

FIG. 12 is an exemplary guide track device according to one embodiment of the present invention with an attached exemplary network interconnectivity apparatus of FIG. 1;

FIG. 13 is an exemplary interior view of an exemplary guide track device with exemplary network interconnectivity apparatuses of FIG. 1;

FIG. 14A is a face view of an exemplary single line network interconnectivity apparatus according to one embodiment of the present invention for use in a computer network;

FIG. 14B is a rear perspective view of the exemplary single line network interconnectivity apparatus of FIG. 14A for use in a computer network;

FIG. 14C is a face view of the exemplary single line network interconnectivity apparatus of FIGS. 14A and 14B which is contained in an exemplary protective shroud;

FIG. 15A is rear, perspective view of an electrical gang box with the exemplary single line network interconnectivity apparatus of FIGS. 14A, 14B, and 14C mounted thereto;

FIG. 15B is face view of an Ethernet outlet faceplate that is connected with an electrical gang box which contains the exemplary single line network interconnectivity apparatus of FIGS. 14A, 14B, and 14C;

FIG. 16 is a block diagram of an exemplary data switch of the exemplary single line network interconnectivity apparatus of FIGS. 14A, 14B, and 14C;

FIG. 17 is a flowchart of an exemplary method for processing data packets at the data switch of the exemplary single line network interconnectivity apparatus of FIGS. 14A, 14B, and 14C;

FIG. 18 is a flowchart of an exemplary method of installing a plurality of the single line network interconnectivity apparatuses of FIGS. 14A, 14B, and 14C;

FIG. 19 is a prior art computer network with a home run connection of a hub connected to a distribution frame and each a plurality of network outlets; and

FIG. 20 is an exemplary computer network according to one embodiment of the present invention with a single continuous connection of a plurality of network outlets to a distribution frame using a plurality of the exemplary single line network interconnectivity apparatuses of FIGS. 14A, 14B, and 14C.

### DETAILED DESCRIPTION OF THE INVENTION

The present invention related to interconnectivity apparatuses and installation methods for telecommunications and computer networks, and to apparatuses and methods for reducing the amount of network cable and other resources required to install network outlets in an environment.

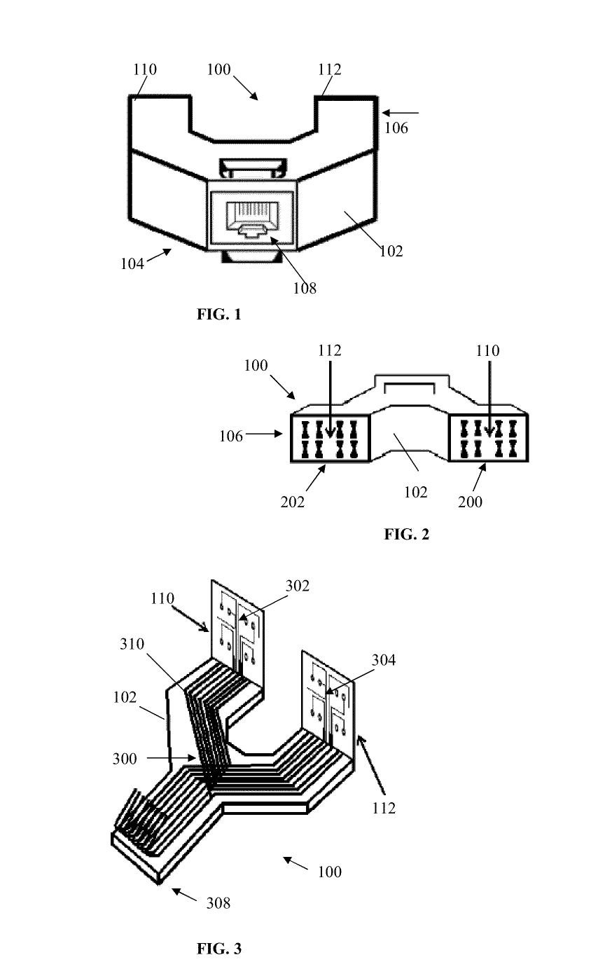

A first aspect of the present invention is directed to an analog network interconnectivity apparatus. An exemplary network interconnectivity apparatus 100 for use in a telecommunications network is illustrated in FIG. 1. In this example, the network interconnectivity apparatus 100 includes a housing 102 including a first side 104 and a second side 106. The first side 104 includes a female port 108 and the second side 106 includes an electronic continuity receiving bay (ECRB) 110 and an electronic continuity continuation bay (ECCB) 112. This technology provides a number of advantages including apparatuses and methods for more efficiently installing network cable and network outlets of telecommunications networks across workstation areas of an environment.

Referring more specifically to FIG. 1, the female port 108 can be a standard RJ45 port, although other female ports for receiving network cable plugs, and/or the male plug of a network outlet adapter apparatus, can also be used.

Referring to FIG. 2, the network interconnectivity apparatus 100 is illustrated as including a plurality of apertures 200 and 202 at the second side 106 of the housing 102 and disposed proximate the ECRB 110 and ECCB 112, respectively. The apertures 200 and 202 are configured to receive wires of a network cable, such as a standard network category 3, 5, 5e, or 6 cable for example, although other cables can also be used. Accordingly, in this example there are eight apertures 200 and 202 corresponding to the eight wires of a standard network cable, although other numbers of apertures can also be used.

Referring to FIG. 3, an exemplary interior, perspective view of the network interconnectivity apparatus 100 is illustrated as including a single to dual electronic circuit board 300 including electrically conductive paths 310. The circuit board 300 can include a plurality of grooves each configured to receive one of the electrically conductive paths 310. The electrically conductive paths 310 can be copper strips, for example, although other electrically conductive materials can also be used.

In this example, the electrically conductive paths 310 extend between a female port positioned at end 308 (see female RJ45 port 108 in FIG. 1) and the ECRB 110 and ECCB 112. Accordingly, the plurality of electrically conductive paths 310 can include, for example, eight copper strips at a female RJ45 port position at end 308 corresponding to the eight wires of a standard network cable, although other numbers of paths can also be used. The eight copper strips in this example extend into two sets of eight copper strips, each set terminating at one of the ECRB 110 and ECCB 112.

The continuity connection points 302 and 304 can be located at the ECRB 110 and ECCB 112 in alignment with the plurality of apertures 200 and 202 (see FIG. 2), respectively. The continuity connection points 302 and 304 can be attached to separate circuit boards or the continuity connection points 302 and 304 can be disposed on an extension of the circuit board 300 to which the plurality of electrically conductive paths 310 are attached. According to this embodiment electrical signals can be received from a network cable at the ECRB 110 and communicated by the circuit board 300 to a telecommunications device attached to a female port positioned at end 308, as well as to the ECCB 112.

Referring to FIG. 4, an exemplary network outlet adapter apparatus 400 for use with the network interconnectivity apparatus 100 is illustrated. In this example, the network outlet adapter apparatus 400 includes a housing 402 including a first side 404 and a second side 406. The first side 404 of the housing 402 includes a female port 410 which can be a standard RJ45 port, although other female ports for receiving network cable plugs or wires can also be used. The second side 406 of the housing 402 includes a male plug 408 configured to be received by the female RJ45 port 108 of the network interconnectivity apparatus 100.

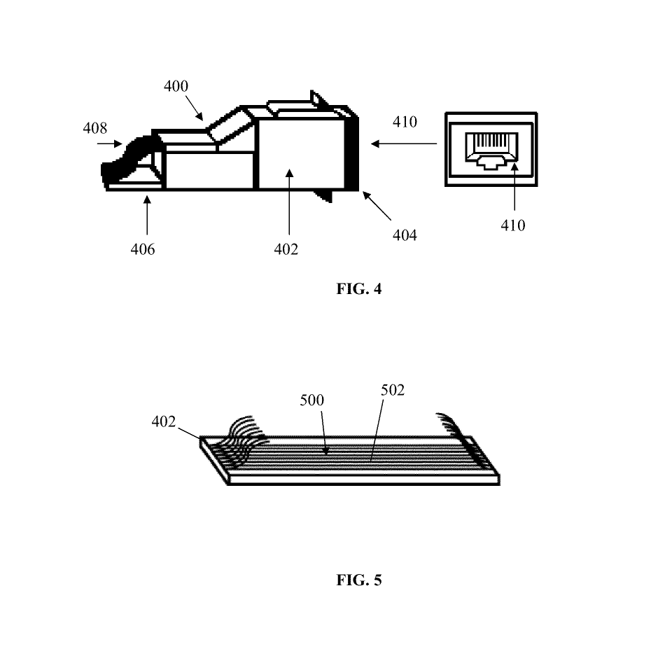

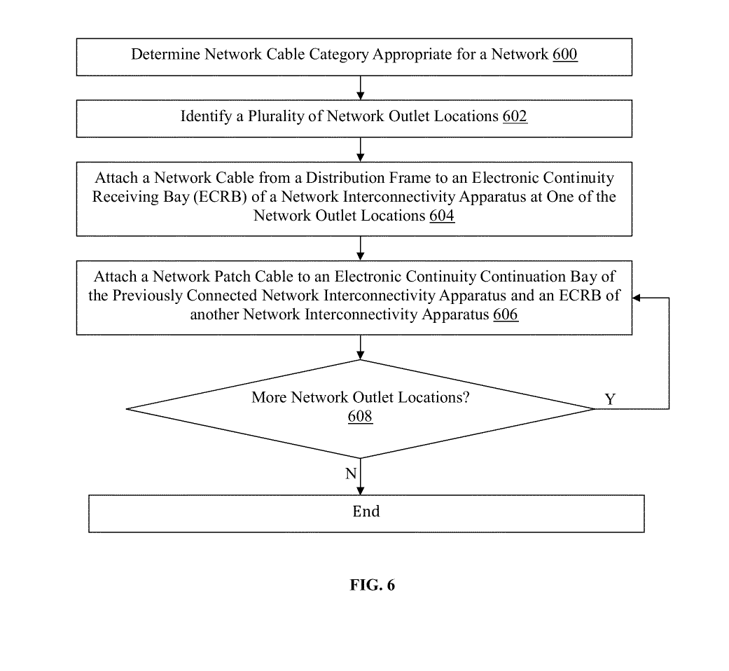

Referring to FIG. 5, the network outlet adapter apparatus 400 further includes a circuit board 500 attached to an interior portion of the housing 402. The circuit board 500 includes electrically conductive paths 502 extending between the female port and the male plug 408 and configured to communicate electric signals between the female port and the male plug 408. The electrically conductive paths can be eight copper strips corresponding to the eight copper strips of the female port 108 of the network interconnectivity apparatus 100 and the eight wires of a standard network cable, although other numbers of paths and electrically conductive material can also be used.

Referring to FIG. 6, an exemplary method for installing a plurality of network interconnectivity apparatuses 100 in a telecommunications network will now be described. In step 600, a network installer determines a network cable category (e.g. 3, 5, 5e, or 6) appropriate for the network based on a desired bandwidth or other performance characteristic of the network, for example. In step 602, the installer selects a plurality of network outlet locations in the environment. The network outlet locations can be determined based on a physical layout of the workstation areas of the environment, for example.

In step 604, the installer attaches a network cable from a main or intermediate distribution frame, for example, to the ECRB 110 of a network interconnectivity apparatus 100 located at one of the network outlet locations. The network cable can be connected by inserting at least one twisted pair of the wires of the network cable through one or more of the apertures 202 of the network interconnectivity apparatus 100. Once inserted, the installer can connect the twisted pair to a set of the continuity connection points 302 of the ECRB 110 of the network interconnectivity apparatus 100 using a punch down tool. Other methods of attaching the network cable to the ECRB 110 can also be used.

In step 606, the installer attaches a network patch cable to the ECCB 112 of the network interconnectivity apparatus 100 and to an ECRB 110 of another network interconnectivity apparatus 100 at a different one of the identified network outlet locations. The network patch cable can be attached to the ECCB 112 of the network interconnectivity apparatus 100 by the same method described earlier for attaching the network cable to the ECRB 110.

The continuity connection points 304 of the ECCB 112 (see FIG. 3) used to connect the network patch cable should correspond with, and be electrically connected to, the continuity connection points 302 used to connect the network cable to the ECRB 110. The installer can then attach the network interconnectivity apparatus 100 to an electrical gang box or guide track at the network outlet location and then mount the network outlet faceplate to the electrical gang box.

In step 608, the installer determines whether there are network outlet locations in the environment in addition to the two locations at which a network interconnectivity apparatus 100 was previously connected. If the installer determines there are additional network outlet locations in the environment, then the Yes (Y) branch is taken to step 606 and a network interconnectivity apparatus 100 at one of the additional network outlet location(s) is connected, as described and illustrated earlier. If the installer determines, in step 608, there are no additional network outlet locations, then the No (N) branch is taken and the method ends.

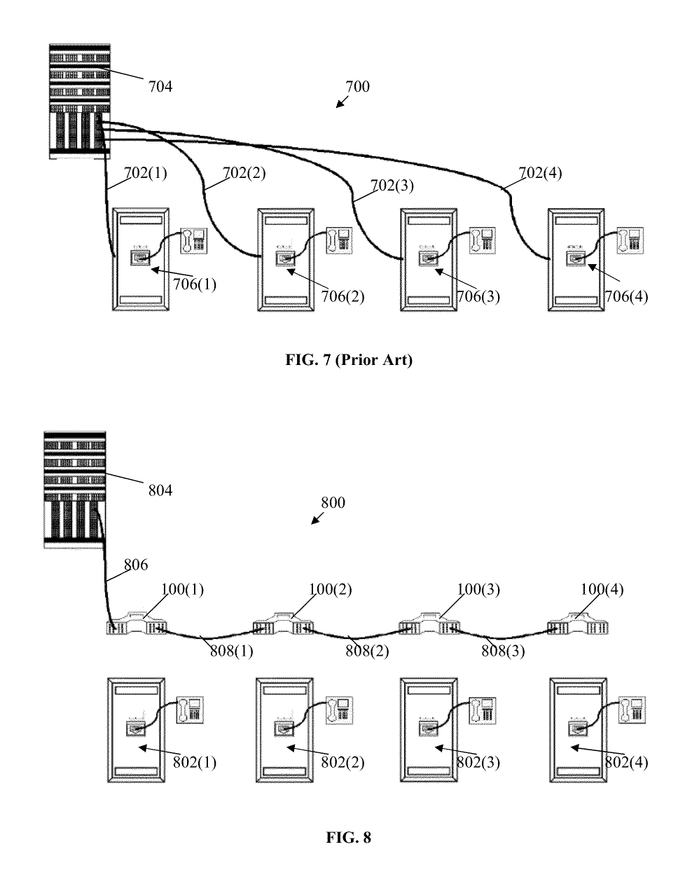

Referring to FIG. 7, a prior art telecommunications network 700 with a home run connection 702(1)-(4) between a distribution frame 704 and each of a plurality of network outlets 706(1)-(4) is illustrated. In the telecommunications network 700, compliance with industry installation standards requires a home run connection 702(1)-(4) to each of the network outlets 706(1)-(4) so that each end terminates at an active device. However, satisfying industry installation standards requires a significant amount of network cable. Additionally, the physical layout of the environment may make installing a new network outlet challenging since a new home run connection to the distribution frame 804 will be required.

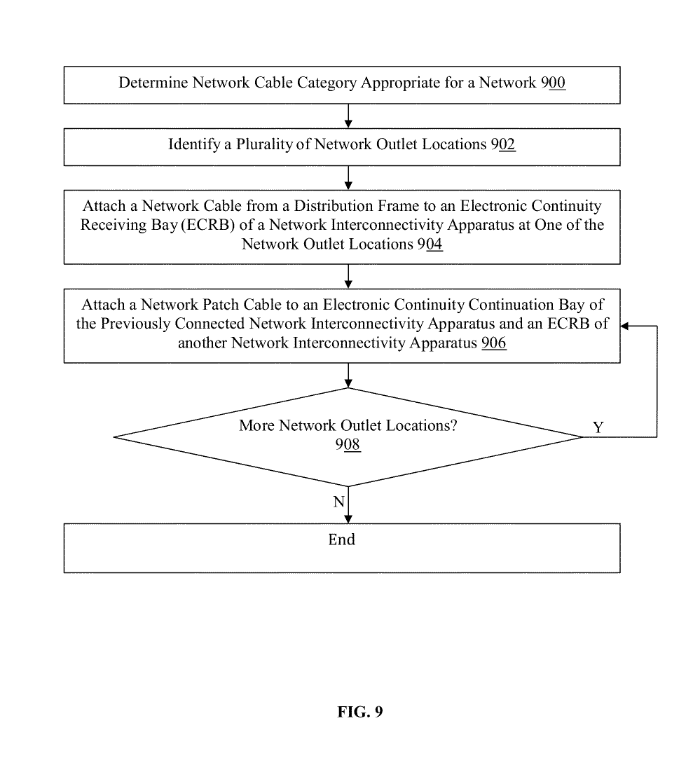

Referring to FIG. 8 and the present invention, an exemplary telecommunications network 800 with a single continuous connection of a plurality of network outlets 802(1)-(4) to a distribution frame 804 using a plurality of network interconnectivity apparatuses 100(1)-(4) is illustrated. In this example, one of the network interconnectivity apparatuses 100(1)-(4) is connected to each of the network outlets 802(1)-(4), respectively. The network interconnectivity apparatus 100(1) is connected to the distribution frame 804 by a network cable 906 attached as described earlier with reference to step 604. The network interconnectivity apparatus 100(1) is connected to the network interconnectivity apparatus 100(2) by a network patch cable 808(1), as described earlier with reference to step 606. The network interconnectivity apparatuses 100(3) and 100(4) are similarly connected with network patch cables 808(2) and 808(3).

In this example, much less network cable is used to connect the network outlets 802(1)-(4), as compared to the telecommunications network 700, while industry installation standards are maintained and a single continuous connection of network cable is provided. Moreover, adding an additional network outlet will only require connecting another network interconnectivity apparatus 100 to one of the network interconnectivity apparatuses 100(1)-100(4) instead of installing a home run connection to the distribution frame 804.

Referring to FIG. 9, an exemplary method of installing a plurality of the network interconnectivity apparatuses 100 in a telecommunications network will now be described. In steps 900 and 902, an installer determines the network cable category appropriate for the network and identifies a plurality of network outlet locations, as described earlier with respect to steps 600 and 602, respectively. In step 904, the installer attaches a network cable from a distribution frame to an ECRB 110 of a network interconnectivity apparatus 100 at one of the network outlet locations.

In step 906, the installer attaches a network patch cable to an ECCB 112 of the network interconnectivity apparatus 100 and an ECRB 110 of another network interconnectivity apparatus 100 at a different identified network outlet location within the workstation area.

In step 908, the installer determines whether there are network outlet locations in the environment in addition to the two locations at which a network interconnectivity apparatus 100 was previously connected. If the installer determines there are additional network outlet locations in the environment, then the Yes (Y) branch is taken to step 906 and a network interconnectivity apparatus 100 at one of the additional network outlet location(s) is connected, as described and illustrated earlier. If the installer determines there are no additional network outlet locations needed within in the environment, then the No (N) branch is taken and the method ends.

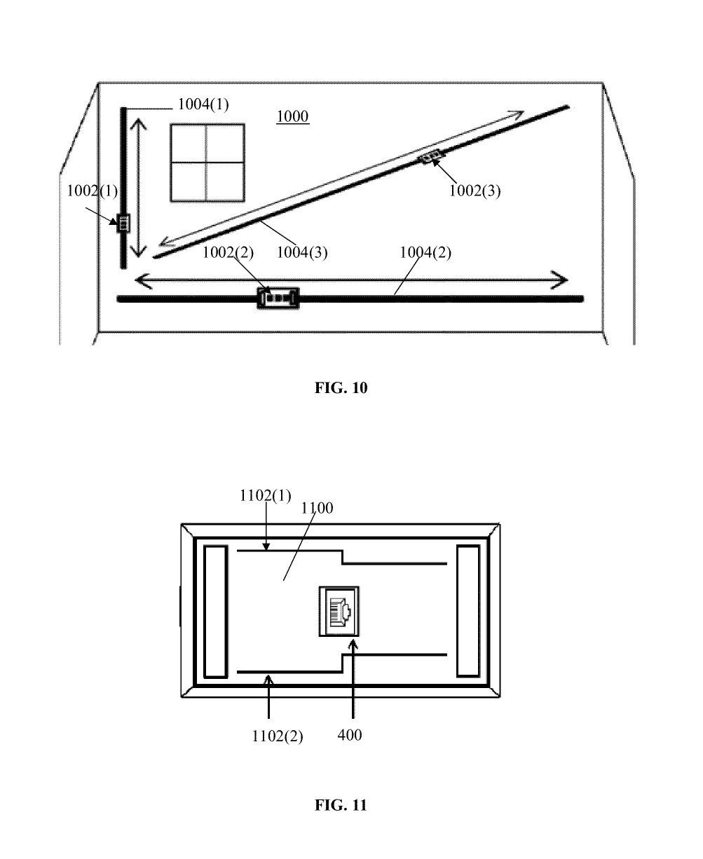

Referring to FIG. 10, an exemplary workstation area 1000 with a plurality of network outlets 1002(1)-1002(3) attached to a plurality of exemplary guide track devices 1004(1)-1004(3), respectively, is illustrated. The guide track devices 1004(1)-(3) can be installed behind a wall or on the exterior of a wall and can extend horizontally, vertically, diagonally, or in any other direction or arrangement. With the guide track devices 1004(1)-1004(3), resources required to reconfigure a workstation area or add new network outlets can be reduced.

Referring to FIG. 11, an exemplary network outlet faceplate 1100 for use with one of the guide track devices 1002(1)-(3) (see FIG. 10) is illustrated. The network outlet faceplate 1100 is configured to receive the network outlet adapter apparatus 400 through an aperture such that the female port of the network outlet adapter apparatus 400 is substantially flush with an exterior portion of the network outlet faceplate 1100. In this example, the network outlet faceplate 1100 is further configured to receive two locking/releasing levers 1102(1)-(2) through two other apertures, although any number of locking/releasing levers 1102(1)-(2) and apertures can be used. The locking/releasing levers 1102(1)-(2) are configured to operatively move the network outlet faceplate 1100 and the network outlet adapter apparatus 400, as described and illustrated in more detail below.

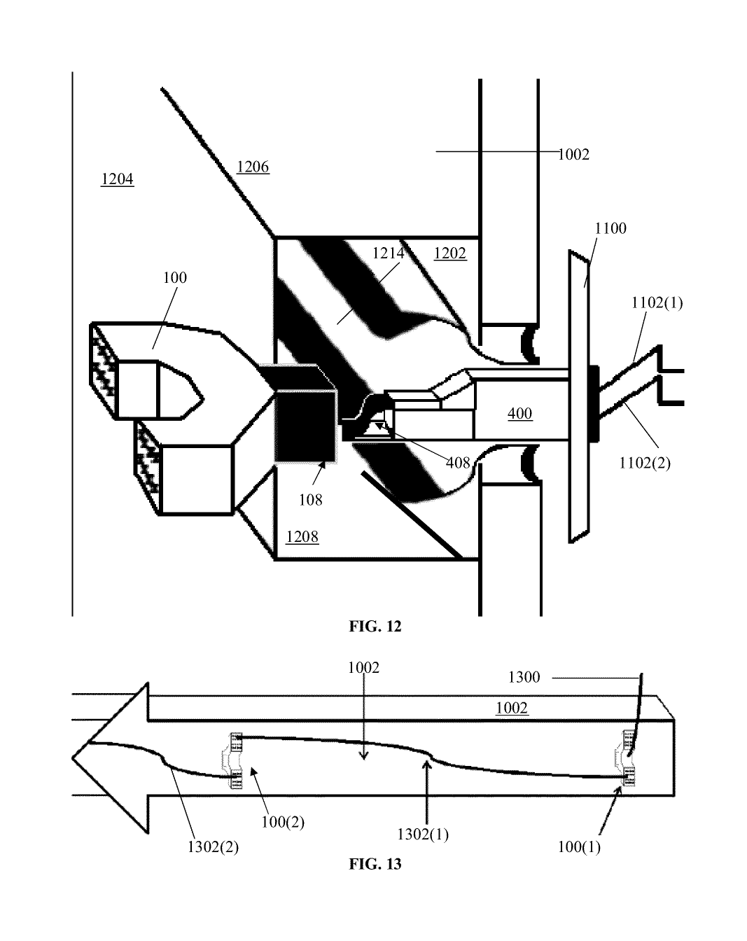

Referring to FIG. 12, a guide track device 1202 with an attached network interconnectivity apparatus 100 is illustrated. The guide track device 1202 includes a front wall 1202, back wall 1204, top wall 1206, bottom wall 1208, and optional end walls (not shown). In this example, the top wall 1206 and back wall 1204 can each include an aperture (not shown) for receiving network cables from a distribution frame or a network patch cable, although any number of apertures can be provided in any of the walls 1202-1208.

The housing 102 of the network interconnectivity apparatus 100 is mounted to at least one of the walls 1202-1208 such that the female port 108 is substantially aligned with a slot 1214. In this example, a network outlet adapter apparatus 400 inserted into the slot 1214 can connect to and disconnect from the network interconnectivity apparatus 100. The network outlet adapter apparatus 400 can be attached to the network outlet faceplate 1100. The locking/releasing levers 1102(1)-(2), when manipulated by a user, can cause the network outlet adapter apparatus 400 and network outlet faceplate 1100 to move away from the front wall 1202 of the guide track device 1002. Optionally, the locking/releasing levers 1102(1)-(2) are configured to move the network outlet adapter apparatus 400 and network outlet faceplate 1100 so that the male plug 408 electrically connects to and disconnects from the female port 108 of the network interconnectivity apparatus 100.

In order to align the network outlet adapter apparatus 400 with the network interconnectivity apparatus 100, the slot 1214 of the guide track device 1002 optionally includes at least one preset groove. The preset groove is configured to receive a portion of the network outlet adapter apparatus 400 such that the male plug 408 of the network outlet adapter apparatus 400 is substantially aligned with the female port 108 of the network interconnectivity apparatus 100. Accordingly, a user can move the network outlet adapter apparatus 400 and attached network outlet faceplate 1100 along the slot 1214 until a preset groove is reached near a desired location for the network outlet in order to reconfigure a workstation area.

Referring to FIG. 13, an exemplary interior view of the guide track device 1002 is illustrated. Two network interconnectivity apparatuses 100(1)-(2) are mounted to the guide track device 1002. In this example, a network cable 1300 from a distribution frame is inserted into the guide track device 1002 through one of the apertures and connected to the network interconnectivity apparatus 100(1), as described earlier with reference to step 904. A network patch cable 1302(1) is then connected to network interconnectivity apparatuses 100(1) and 100(2), as described earlier with reference to step 906. Another network patch cable 1302(2) is connected to network interconnectivity apparatus 100(2) and another network interconnectivity apparatus (not shown), also as described earlier with reference to step 906.

Accordingly, the guide track device 1002 can be used to mount network interconnectivity apparatus 100 that is connected by a single continuous connection of network cable thereby reducing the amount of network cable required to connect network outlets. Additionally, the network interconnectivity apparatus 100 is moveable within the guide track device 1002 providing flexibility with respect to the configuration of a workstation area.

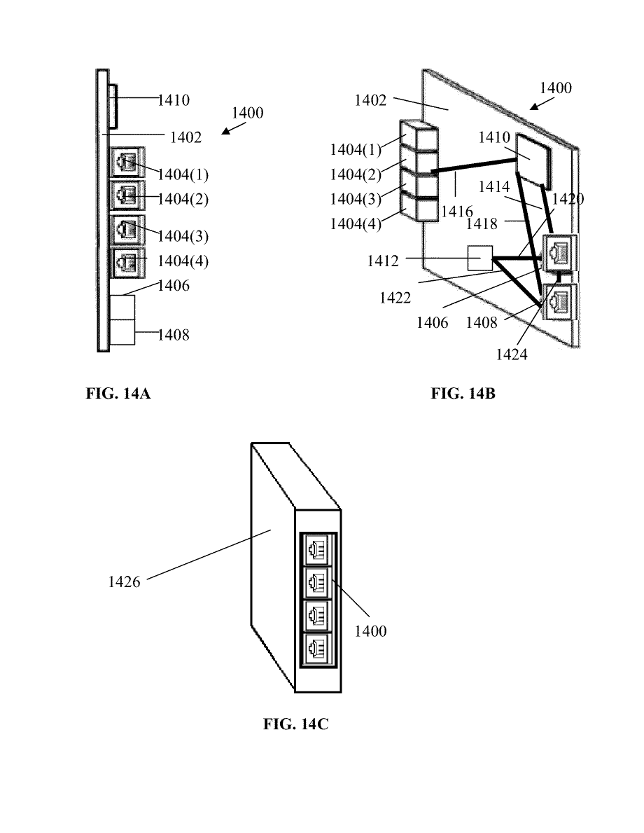

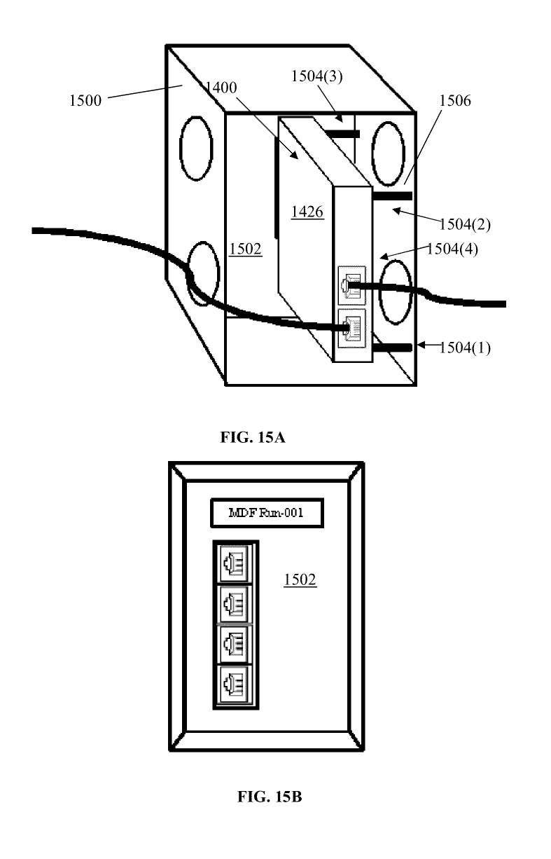

A face view of an exemplary single line network interconnectivity apparatus 1400 for use in a computer network is illustrated in FIG. 14A and a rear perspective view of the single line network interconnectivity apparatus 1400 is illustrated in FIG. 14B. In this example, the single line network interconnectivity apparatus 1400 includes a system board 1402 having mounted thereto four female Ethernet ports 1404(1)-(4), an Ethernet data receiving port (EDRP) 1406, an Ethernet data transfer port (EDTP) 1408, a data switch 1410, and an optional electronic data repeater 1412. Although the exemplary single line network interconnectivity apparatus includes four female Ethernet ports 1404(1)-(4), any number of female Ethernet ports can be used. In some examples, the EDRP 1406 and the EDTP 1408 include a plurality of split copper punch down pins mounted to the system board 1402. In other examples, the EDRP 1406 and the EDTP 1408 are RJ45 plugs. Other electrically conductive material and structures can be used as a network cable interface.

As illustrated in FIG. 14B, the EDRP 1406 is configured to receive electric signals comprising network data packets from a network cable and communicate the data packets to the data switch 1410 over a first electrically conductive communication path 1414. In some examples, the EDRP 1406 is further configured to receive electrical power, used by a plurality of the components of the single line network interconnectivity apparatus 1400, from the network cable in the form of power over Ethernet (POE), as is known in the art. The received data packets are operatively communicated by the data switch 1410 to one of the female Ethernet ports 1404(1)-(4) over a second electrically conductive communication path 1416.

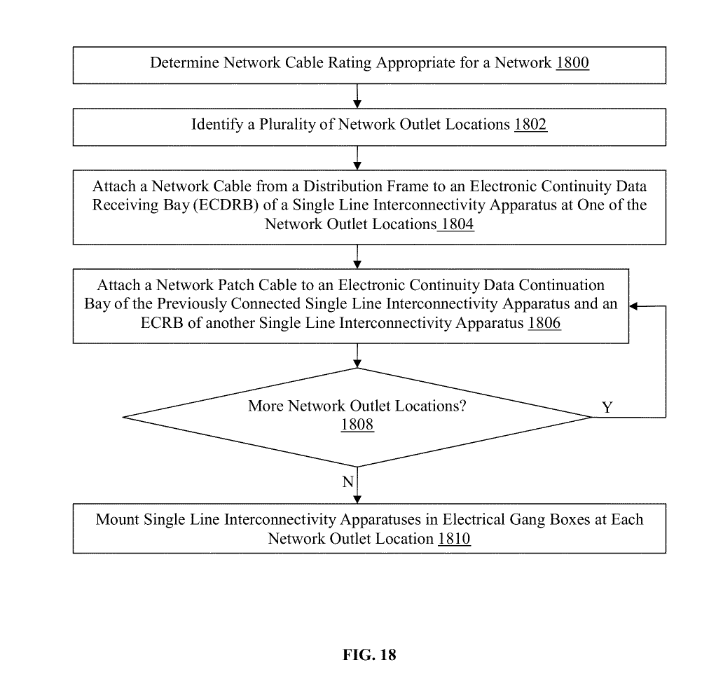

Alternatively, the data packets are operatively communicated to the EDTP 1408 by the data switch 1410 over a third electrically conductive communication path 1418. The communication of the data packets is described and illustrated in more detail later with reference to FIG. 18. In this example, the single line network interconnectivity apparatus 1400 further includes an electronic data repeater 1412 connected to the EDRP 1406 and EDTP 1408 by fourth and fifth electrically conductive paths 1420 and 1422, respectively. The electronic data repeater 1412 is configured to maintain integrity and signal quality within network environments with long segments or ranges between each single line network interconnectivity apparatus 1400 and the network as a whole by repeating packets across the EDRP 1406 and EDTP 1408.

In this example, the single line network interconnectivity apparatus 1400 further includes a sixth electrically conductive path 1424 extending between the EDRP 1406 and the EDTP 1408. The sixth electrically conductive path 1424 facilitates bypassing of the data switch 1410, such as when the data switch 1410 is in a failure state, as described and illustrated in more detail later. In some examples, the first, second, third, fourth, fifth and sixth electrically conductive communication paths 1414, 1416, 1418, 1420, 1422, and 1424 are integral with the system board 1402 and include eight copper strips, although the communication paths 1414, 1416, 1418, 1420, 1422, and 1424 can include strips of other electrically conductive material and other electrically conductive paths can also be used.

A face view of the exemplary single line network interconnectivity apparatus 1400 contained in an exemplary protective shroud 1426 is illustrated in FIG. 14C. In this example, the single line network interconnectivity apparatus 1400 is housed in a durable shroud 1426 in order to protect the electrical components from handling. The shroud 1400 can be configured to be received by and attached to an electrical gang box.

Referring to FIG. 15A, an electrical gang box 1500 with the single line network interconnectivity apparatus 1400 mounted thereto is illustrated. An optional plurality of risers 1504(1)-(4) are attached to the single line network interconnectivity apparatus 1400 and operate to maintain space between a side 1506 of the electrical gang box 1500 and the shroud 1426 for proper heat dissipation and/or alignment of the single line network interconnectivity apparatus 1400, for example. Although four risers 1504(1)-(4) are shown in this example, any number of risers can be used.

Referring to FIG. 15B, a face view of an Ethernet outlet faceplate 1502 that is connected with an electrical gang box 1500 which contains the exemplary single line network interconnectivity apparatus 1400 is illustrated. In this example, the female Ethernet ports 1404(1)-(4) are configured to be received by an aperture of the network outlet faceplate 1502 so that the female Ethernet ports 1404(1)-(4) are substantially flush with an exterior portion of the network outlet faceplate 1502.

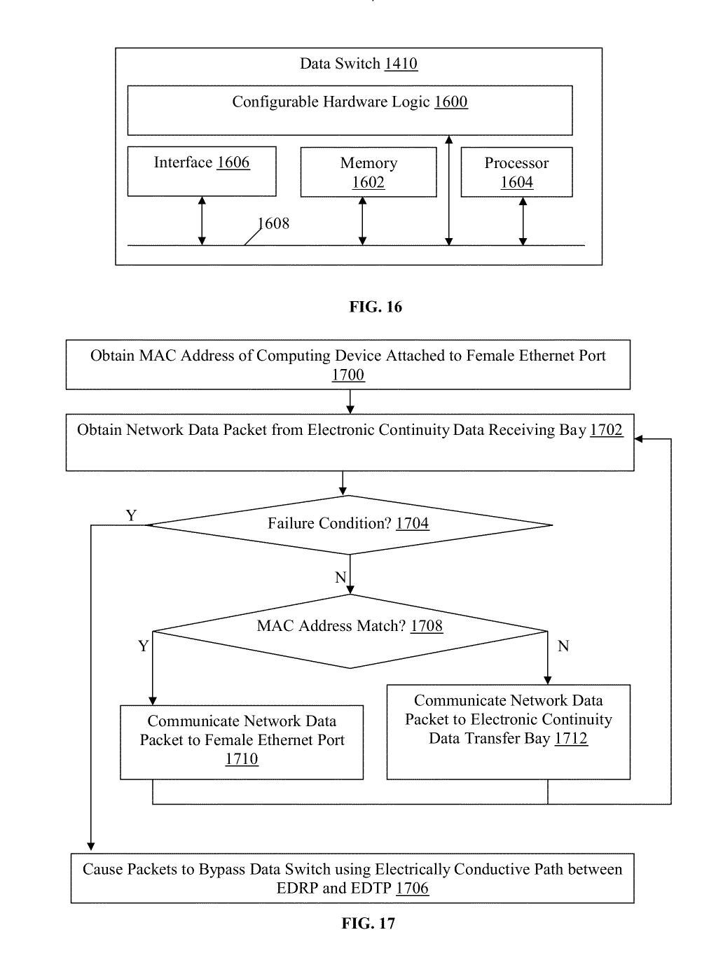

Referring to FIG. 16, a block diagram of an exemplary data switch 1410 of the system board 1402 of the single line network interconnectivity apparatus 1400 is illustrated. In this example, the data switch 1410 includes configurable hardware logic 1600, a memory 1602, a processor 1604, and an interface 1606 coupled to a bus 1608 or other link. The interface is configured to receive data from and communicate data to the first, second, and third electrically conductive paths 1412, 1414, and 1416. In other examples, the data switch 1410 can include only a subset of these components and other components can also be used in the data switch 1410.

The configurable hardware logic 1600 of the data switch 1410 may include specialized hardware configured to implement one or more steps of this technology, as illustrated and described with reference to the examples herein. By way of example only, the configurable hardware logic 1600 may include one or more field programmable gate arrays (FPGAs), field programmable logic devices (FPLDs), application specific integrated circuits (ASICs), and/or programmable logic units (PLUs), although other types of configurable hardware logic can also be used.

The memory 1602 of the data switch 1410 can include one or more tangible storage media and/or devices, such as RAM, ROM, flash memory, solid state memory, or any other memory storage types or devices or non-transitory computer readable medium, including combinations thereof, which are known to those of ordinary skill in the art. The memory 1602 of the data switch 1410 may store one or more instructions of this technology as illustrated and described with reference to the examples herein. The processor 1604 of the data switch 1410 may execute the one or more computer-executable instructions stored in the memory 1600 for one or more aspects of this technology. The processor 1604 of the data switch 1410 may include one or more central processing units (CPUs) or general purpose processors with one or more processing cores, although other types of processors could be used.

Referring to FIG. 17, an exemplary method for processing data packets at the data switch 1410 of the system board 1402 of the single line network interconnectivity apparatus 1400 will now be described. In step 1700, the data switch 1410 obtains a unique identifier associated with each computing device attached to the female Ethernet ports 1404(1)-(4). In this example, the unique identifier is the media access control (MAC) address of each computing device, although other unique identifiers can also be used.

The data switch 1410 can obtain the unique identifier upon initialization or upon detecting a new connection to a computing device, for example. Additionally, the data switch 1410 can obtain the unique identifiers by pinging the attached computing devices using the second electrically conductive path 1414 or by monitoring communications for source or destination information, such as in a header of a data packet for example. Other methods of obtaining the unique identifiers can also be used. Once obtained, the data switch 1410 optionally stores the unique identifiers with the configurable hardware logic 1600 or in the memory 1602, for example.

In step 1702, the data switch 1410 obtains a network data packet from the EDRP 1406 using the first electrically conductive communication path 1412. In step 1704, the data switch 1410 determines whether a failure condition has occurred. The failure condition can result from the data switch 1410 failing to properly obtain network packets from the ECRP 1406. If the single line network interconnectivity apparatus 1400 is in a failure state, then the Yes (Y) branch is taken to step 1706. In step 1706, the data switch 1410 causes packets to bypass the data switch 1410, such as by sending an indication of the failure to the EDRP 1406, using the sixth electrically conductive path 1424 extending between the EDRP 1406 and the EDTP 1408. The indication can be an electrical communication that reroutes packets obtained at the EDRP to the EDTP so that one or more downstream single line network interconnectivity apparatuses 1400 and associated computing devices can continue to receive the packets.

Referring back to step 1704, if the data switch 1410 determines a failure condition has not occurred, then the No (N) branch is taken to step 1708. In step 1708, the data switch 1410 determines whether a MAC address included in a header of the obtained data packet matches one of the MAC addresses associated with the connected computing devices obtained in step 1700. If the data switch 1410 determines that the MAC address included in the obtained data packet matches one of the MAC addresses associated with the connected computing devices, then the Yes (Y) branch is taken to step 1710.

In step 1710, the data switch 1410 communicates the data packet to one of the female Ethernet ports 1404(1)-1404(4) to which the computing device having the matching MAC address is connected. Accordingly, data packets are only forwarded to one of the computing devices attached to the single line network interconnectivity apparatus 1400 when the data switch 1410 determines the computing device is the intended destination of the data packet.

Referring back to step 1708, if the data switch 1410 determines that the MAC address included in the obtained data packet does not match one of the MAC addresses associated with the connected computing devices, then the No (N) branch is taken to step 1712. In step 1712, the data switch 1410 communicates the data packet to the EDTP 1408 using the third electrically conductive communication path 1416. In this example, the data packet is only forwarded to another single line network interconnectivity apparatus when the data switch 1410 determines that an attached computing device is not the intended destination of the network packet, thereby maintaining integrity of the data. Accordingly, data packet switching advantageously occurs before data packets are communicated to a computing device.

Referring to FIG. 18, an exemplary method of installing a plurality of the single line network interconnectivity apparatuses 1400 in an environment will now be described. In steps 1800 and 1802, an installer determines the network cable category appropriate for the network and identifies a plurality of network outlet locations. In step 1804, the installer attaches a network cable from a distribution frame to an EDRP 1406 of a single line network interconnectivity apparatus 1400 at one of the network outlet locations. The network cable can be connected using a cable plug with an RJ45 female port or with a punch down tool, for example, although other methods of attaching the network cable to the EDRP 1406 can also be used.

In step 1806, the installer attaches a network patch cable to an ECDCB 1408 of the single line network interconnectivity apparatus 1400 and an EDRP 1406 of another single line network interconnectivity apparatus 1400 at a different network outlet location. The network patch cable can be attached to the ECDCB 1408 of the single line network interconnectivity apparatus 1400 by the same method described earlier for attaching the network cable to the EDRP 1406.

In step 1808, the installer determines whether there are network outlet locations in the environment in addition to the two locations at which a single line network interconnectivity apparatus 1400 was previously connected. If the installer determines there are additional network outlet locations in the environment, then the Yes (Y) branch is taken to step 1806 and a single line network interconnectivity apparatus 1400 at one of the additional network outlet location(s) is connected, as described and illustrated earlier. If the installer determines there are no additional network outlet locations in the environment, then the No (N) branch is taken to step 1810.

In step 1810, the installer mounts each single line network interconnectivity apparatus 1400 and shroud 1426 to an electrical gang box 1500 at each of the network outlet locations. Optionally, a computing device is then connected to one or more of the female Ethernet ports 1404(1)-1404(2) of the single line network interconnectivity apparatus 1400 at one or more of the network outlet locations.

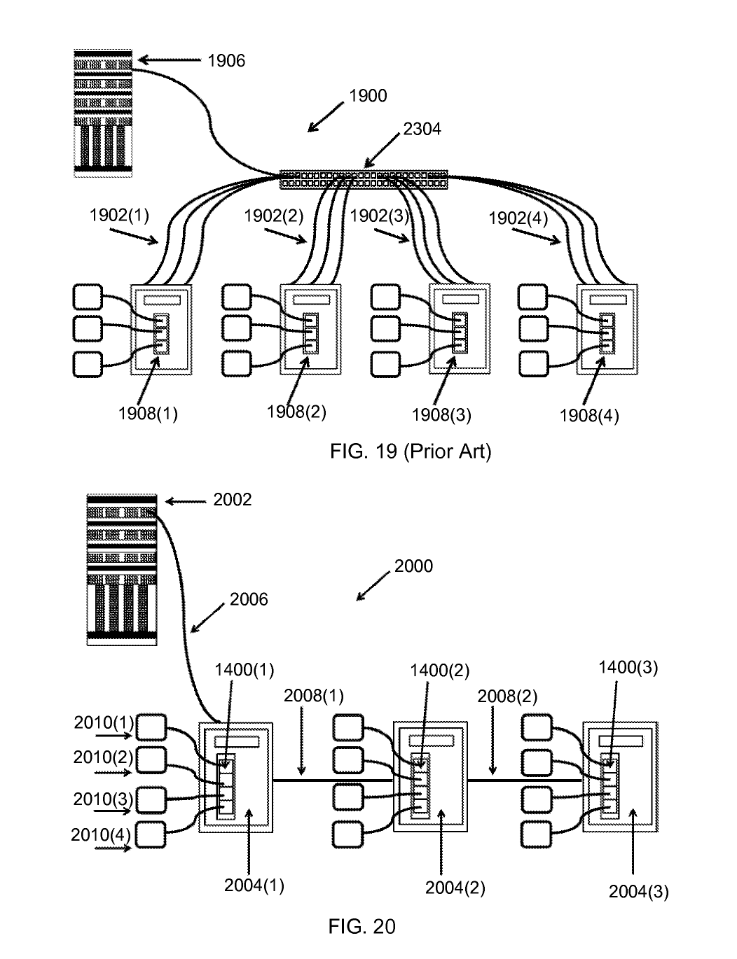

Referring to FIG. 19, a prior art computer network 1900 with four sets of three home run connections 1902(1)-(4) between a hub 1904 connected to a distribution frame 1906 and a plurality of network outlets 1908(1)-(4) is illustrated. In the computer network 1900, compliance with industry installation standards requires a set of three home run connections 1902(1)-(4) to each of the network outlets 1908(1)-(4), respectively, so that each end terminates at an active device. However, satisfying industry installation standards requires a significant amount of network cable. Additionally, the physical layout of the environment may make installing a new network outlet challenging since a new home run connection to the hub 1904 will be required.

Referring to FIG. 20 and the present invention, an exemplary computer network 2000 with a single continuous connection from a distribution frame 2002 to a plurality of single line network interconnectivity apparatuses 1400(1)-(3) at each of a plurality of network outlets 2004(1)-(3) is illustrated. In this example, one of the single line network interconnectivity apparatuses 1400(1)-(3) is connected to each of the network outlets 2404(1)-(3), respectively. The single line network interconnectivity apparatus 1400(1) is connected to the distribution frame 2002 by a network cable 2006, as described earlier with reference to step 1804. The single line network interconnectivity apparatuses 1400(2)-(3) are connected to the single line network interconnectivity apparatus 1400(1) by network patch cables 2008(1)-(2), respectively, as described earlier with reference to step 1806.

In this example, network traffic received by single line network interconnectivity apparatus 1400(1) from the distribution frame 2002 will only be forwarded to network interconnectivity apparatus 1400(2) when the single line network interconnectivity apparatus 1400(1) determines the intended destination of the network traffic is not one of the computing devices 2010(1)-(4) connected to the single line network interconnectivity apparatus 1400(1). Otherwise, the network traffic will be communicated to the appropriate one of the computing devices 2010(1)-(4) connected to the single line network interconnectivity apparatus 1400(1). By providing the data switch 1410 at the single line network interconnectivity apparatuses 1400(1)-(3), data integrity is advantageously maintained without a home run connection to each of the network outlets 2004(1)-(3).

Accordingly, as illustrated and described herein this technology provides a number of advantages including interconnectivity apparatuses and installation methods that reduce the amount of resources and network cable required to install a telecommunications or computer network that complies with industry installation standards. With this technology, a single continuous connection of network cable can be provided to a plurality of network outlets in a computer network while maintaining data integrity.

Moreover, fewer resources are required to reconfigure physical or logical layouts of telecommunications and computer networks while still providing a single continuous connection of network outlets using a reduced amount of network cable. This technology also helps reduce unnecessary and expensive equipment in addition to network cabling, such as complex distribution frame switches, cable racks, distribution frame racks, industrial uninterruptible power supplies, extra cooling devices for the distribution frame room, less distribution frame rooms, and many other items.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A network interconnectivity apparatus, comprising:
a housing comprising a first side and a second side, wherein the first side comprises a female port and the second side comprises an electronic continuity receiving bay (ECRB) and an electronic continuity continuation bay (ECCB) each comprising a plurality of continuity connection points; and
a single to dual electronic circuit board attached to the housing and comprising a plurality of electrically conductive paths extending between the female port and the ECRB and ECCB, wherein the electrically conductive paths are configured to communicate electric signals comprising data packets received by the plurality of continuity connection points of the ECRB to at least one of the female port or the plurality of continuity connection points of the ECCB.

2. The apparatus as set forth in claim 1, wherein the single to dual electronic circuit board comprises a plurality of grooves each configured to receive one of the electrically conductive paths.

3. The apparatus as set forth in claim 1, wherein the plurality of electrically conductive paths comprise eight copper strips and the plurality of continuity connection points comprise eight continuity connection points each attached to one of the copper strips.

4. The apparatus as set forth in claim 1, wherein the housing is configured to be received at a fitted port of a network outlet faceplate attached to an electrical gang box.

5. The apparatus as set forth in claim 1, wherein the housing is substantially U-shaped and the single to dual electronic circuit board has a shape substantially similar to that of the housing.

6. The apparatus as set forth in claim 1, further comprising a guide track device comprising at least front, back, top, and bottom walls, wherein at least one of the back, top, or bottom walls comprises an aperture for receiving at least one network cable, the front wall comprises a slot, and the housing is mounted to at least one of the back, top, or bottom walls such that the female port of the housing is substantially aligned with the slot.

7. The apparatus as set forth in claim 6, wherein the slot of the guide track device further comprises at least one preset groove configured to receive a portion of a network outlet adapter apparatus such that a male plug of the network outlet adapter apparatus is substantially aligned with the female port of the housing.

8. The apparatus as set forth in claim 6, wherein the male plug of the network outlet adapter apparatus is an RJ45 connector and the female port is configured to receive the RJ45 connector.

9. A network outlet adapter apparatus, comprising:
a housing comprising a first side and a second side, the first side comprises a female port and the second side comprises a male plug;
a circuit board attached to the housing and comprising a plurality of electrically conductive paths extending between the female port and the male plug and configured to communicate electric signals between the female port and the male plug;
a network outlet faceplate configured to receive the housing through an aperture and attach to the housing toward the first end; and
at least one locking/releasing lever extending through the network outlet faceplate and configured to operatively move both the network outlet faceplate and the housing away from a guide track device when the housing is received by a slot of the guide track device.

10. The apparatus as set forth in claim 9, wherein the at least one locking/releasing lever is further configured to, when manipulated by a user, move both the network outlet faceplate and the housing such that the male plug electrically connects with or disconnects from a female port of a network interconnectivity apparatus attached to the guide track device.

11. The apparatus as set forth in claim 9, wherein the male plug of is an RJ45 connector and the female port is configured to receive the RJ45 connector.

12. A single line network interconnectivity apparatus, comprising:
a system board, one or more female Ethernet ports, an Ethernet data receiving port (EDRP), an Ethernet data transfer port (EDTP), and a data switch comprising at least one of (i) configurable hardware logic configured to implement or (ii) a processor coupled to a memory and configured to execute programmed instructions stored in the memory comprising:
obtaining at least one network data packet from the EDRP;
determining whether an identifier included in the at least one network data packet matches an identifier associated with a computing device connected to the female Ethernet port;
communicating the at least one network data packet to the female Ethernet port, when it is determined that the identifier included in the at least one network packet matches the identifier associated with the computing device connected to the female Ethernet port; and
communicating the at least one network data packet to the EDTP, when it is determined that the identifier included in the at least one network packet does not match the identifier associated with the computing device connected to the female Ethernet port.

13. The apparatus as set forth in claim 12, further comprising an electronic data repeater.

14. The apparatus as set forth in claim 12, further comprising an electrically conductive communication path extending between the EDRP and the EDTP and configured to communicate the at least one network data packet from the EDRP to the EDTP upon failure of the data switch.

15. The apparatus as set forth in claim 12, further comprising:
an electrical gang box; and
a plurality of riser posts disposed between the system board and the electrical gang box and configured to maintain separation from the electrical gang box when received by the electrical gang box and attached to a network outlet faceplate attached to the gang box.

16. The apparatus as set forth in claim 12, wherein the identifier associated with the computing device connected to the female Ethernet port is stored by the data switch and comprises a media access control (MAC) address of the electronic device connected to the female Ethernet port.

17. The apparatus as set forth in claim 12, wherein the at least one network data packet is obtained from the EDRP over a first electrically conductive communication path, the at least one network data packet is communicated to the female Ethernet port over a second electrically conductive communication path, the at least one network data packet is communicated to the EDTP over a third electrically conductive communication path, and the first, second, and third electrically conductive communication paths are integral with the system board and each comprise eight copper strips.

18. The apparatus as set forth in claim 12, wherein the EDRP is configured to receive the at least one network data packet and electrical power from a network cable via power over Ethernet.
